(19) United States
(12) Patent Application Publication
(10) Pub. No.: US 2008/0059110 A1
(43) Pub. Date: Mar. 6, 2008

(54) Semiconductor integrated circuit supplying temperature signal as digital value

(75) Inventors: Hiroki Fujisawa, Tokyo (JP); Hitoshi Tanaka, Tokyo (JP); Atsuo Koshizuka, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ELPIDA MEMORY, INC., Tokyo (JP)

(21) Appl. No.: 11/896,295

(22) Filed: Aug. 30, 2007

(30) Foreign Application Priority Data
Aug. 31, 2006 (JP) 2006-234922

(51) Int. Cl. G01K 1/00

(52) U.S. Cl. 702/130

(57) ABSTRACT

A semiconductor integrated circuit includes a temperature detecting unit that detects the temperature of a chip, and an A/D converter that converts an analog output VBE from the temperature detecting unit into a digital output. The A/D converter includes an up/down counter, a D/A converter that converts an output T2 from the up/down counter into an analog output, and a comparator that compares the analog output DAC_OUT of the D/A converter and the analog output VBE (VTEMP) of the temperature detecting unit. The up/down counter is adapted to be able to preset an initial value that is different from the minimum value or the maximum value. Accordingly, the determination time required at the initial conversion can be reduced although the linear search method is used.

### TECHNICAL FIELD

The present invention relates to a semiconductor integrated circuit, and, more particularly to a semiconductor integrated circuit including an analog-to-digital (A/D) converter that outputs a temperature of a chip as a digital value. The present invention also relates to a data processing system that includes a semiconductor memory device including an A/D converter that outputs a temperature of a chip as a digital value.

### BACKGROUND OF THE INVENTION

A DRAM (dynamic random access memory), which is a typical semiconductor memory device, performs self-refresh operation at predetermined intervals to keep stored information. Usually, the self-refresh operation is performed periodically. Therefore, a self-refresh timer circuit that controls timing of the self-refresh operation is incorporated in the DRAM. Generally, as the cycle of the self-refresh timer becomes longer, current consumption by the DRAM decreases more. For example, in DRAMs used for mobile devices and the like, reduction of the power consumption during the standby mode is strongly desired. Therefore, it is preferable that the self-refresh operation be performed using as long timer cycle as possible.

It is known that the data holding time of a memory cell in the DRAM exhibits a temperature dependency, and that the data holding time reduces according to the power of an increase in the temperature. Therefore, even when a predetermined timer cycle is set to assure an appropriate data holding time at room temperatures, it is assumed that the timer cycle can exceed the data holding time in environments at high temperatures, which leads to an inappropriate refreshing operation.

In view of such a problem, various methods for controlling the timer cycle according to temperatures have been proposed. For example, in a method described in “A Low-Power 256-Mb SDRAM With an On-Chip Thermometer and Biased Reference Line Sensing Scheme”, IEEE Journal of Solid-State Circuits, Vol. 38, No. 2, February 2003, a semiconductor memory device is provided with a temperature measuring unit, and the timer cycle is changed in a stepwise fashion based on the measured temperature. In addition, for example, in a method described in Japanese Patent Application Laid-open No. 2002-117671, a diode whose characteristics vary according to the power of the temperature is used, and its temperature characteristics are properly controlled to adjust the timer cycle so as to be adapted to the data holding time.

However, according to the method described in “A Low-Power 256-Mb SDRAM With an On-Chip Thermometer and Biased Reference Line Sensing Scheme”, when the timer cycle is changed in a stepwise fashion based on the temperature, the timer cycle changes sharply at the switching temperature point.

For example, when the timer cycle is changed in a stepwise fashion at switching temperature points Tp1, Tp2, and Tp3, as shown in FIG. 10, the control is performed according to temperature characteristics not exceeding temperature characteristics Cm of the data holding time of the memory cell. In this case, the linear temperature characteristics Cm of the data holding time are approximated by a stepwise waveform. Accordingly, when the number of the switching temperature points is smaller, the timer cycle is significantly different from and is shorter than the data holding time near the switching temperature points. Consequently, the current consumption cannot be sufficiently reduced.

To overcome this problem, the timer cycle can be controlled by setting many switching temperature points so as to have a multi-step waveform. In this case, however, component parts that sets the timer cycle to be changed, such as a switching circuit, a programming decoder, and a fuse, are increased, which leads to an increase in the layout area. Further, more time is needed for an adjustment operation to correct the timer cycle.

According to a method described in Japanese Patent Application Laid-open No. 2002-117671, plural diodes that are connected in series are required to finely control the temperature characteristics of the timer cycle. However, considering that the forward drop voltage of a diode is approximately 0.6 V, the number of diodes that can be connected is limited by the supply voltage. For example, when the operation voltage is decreased to 1.5 V, the number of diodes that can be connected in series is limited to two. Therefore, fine control of the timer cycle is obstructed. Such a configuration that plural diodes are connected in series is unfavorable in view of a decrease in the voltage of the DRAM.

To solve such a problem, one of present inventors has proposed an improved self-refresh timer (Japanese Patent Application Laid-open No. 2006-172526).

Recent DRAMs have achieved the data transfer rates exceeding 1 Gbps. Accordingly, a chip produces considerable heat during the normal operation. Therefore, a function of notifying an external controller of the temperature of a chip has been demanded recently. This function enables such control that a DRAM having a low temperature is preferentially used, or the clock frequency of a DRAM having a high temperature is lowered. Further, control of changing an air volume of a cooling fan according to the temperatures of the chip is also possible.

A self-refresh timer circuit described in the Japanese Patent Application Laid-open No. 2006-172526 continuously changes the refresh cycle based on the temperature of the chip. Therefore, information relating to the temperature is handled as an analog value. Thus, an external controller cannot be notified of the information of the self-refresh timer circuit as it is.

To notify the external controller of the information relating to the temperature of the chip, an A/D converter that converts the information relating to the chip temperature into a digital value is required.

As the A/D converter, a successive approximation A/D converter that internally has a D/A (digital-to-analog) converter is widely used. The successive approximation A/D converters are grouped into a type using a dichotomizing search method and a type using a linear search method.

An A/D converter using the dichotomizing search method successively determines output values from a most significant bit (MSB) to a least significant bit (LSB). This type of A/D converter requires the number of determinations that is equal to the number of bits to obtain an output value. Therefore, it is advantageous in that the output value is decided with a relatively small number of determinations. However, since the determinations corresponding to the number of bits are required at each A/D conversion, a certain determination time is needed disadvantageously when the output value is updated, regardless of whether a difference from the previous output value is large or small.

An A/D converter using the linear search method obtains an output digital value by incrementing or decrementing an output digital value. In this type of the A/D converter, the number of determinations required to obtain an output value depends on a difference between an initial value and an output value. Therefore, a longer determination time is needed at an initial conversion, while, at the second and following conversions, the determination is completed quickly by using the previous output value as the initial value.

As an A/D converter that notifies the external controller of the information relating to the chip temperature, both types of the A/D converters can be used. However, since a minute difference in the potential must be correctly determined at the A/D conversion, influences of noises must be eliminated as much as possible. Therefore, the operation of the DRAM core is preferably stopped during the A/D conversion. In this case, a read operation or a write operation cannot be executed during the A/D conversion. Accordingly, the A/D conversion must be completed as quickly as possible.

Considering this, it is considered that an A/D converter using the linear search method is preferable as the A/D converter that notifies the external controller of the information relating to the chip temperature. The output cycle of the information relating to the chip temperature is, for example, approximately 128 ms, and accordingly it is assumed that an obtained output value is not changed so much from the previous output value.

However, when the A/D converter using the linear search method is employed, a long determination time is required at the initial conversion. Therefore, a start-up time at the powering-on or resetting of a DRAM can be longer. To solve this problem, both of the A/D converter using the dichotomizing search method and the A/D converter using the linear search method are prepared to use the former at the initial conversion and the latter at the second and subsequent conversions, as described in Japanese Patent Application Laid-open No. 2005-159702. However, this method disadvantageously increases the circuit scale.

### SUMMARY OF THE INVENTION

The present invention has been achieved to solve the above problems. Therefore, an object of the present invention is to provide an improved semiconductor integrated circuit including an A/D converter that outputs a temperature of a chip as a digital value.

Another object of the present invention is to provide a semiconductor integrated circuit that can reduce a time required for an initial conversion by an A/D converter using the linear search method.

Still another object of the present invention is to provide a semiconductor integrated circuit that linearly changes a self-refresh cycle based on a temperature of a chip, in which the chip temperature can be outputted as a digital value.

The above and other objects of the present invention can be accomplished by a semiconductor integrated circuit comprising:

a temperature detecting unit that detects a chip temperature; and

an A/D converter that converts an analog output of the temperature detecting unit into a digital output,

the A/D converter including:

an up/down counter;

a D/A converter that converts an output from the up/down counter into an analog output; and

a comparator that compares the analog output of the D/A converter and the analog output of the temperature detecting unit,

the up/down counter can preset an initial value different from a minimum value or a maximum value.

According to the present invention, an initial value that is different from the minimum value or the maximum value can be preset at the up/down counter. Therefore, the determination time required at the initial conversion can be reduced, although the linear search method is used. Accordingly, the start-up time at the powering-on or resetting can be reduced.

As the initial value that is preset at the up/down counter, an intermediate value of the up/down counter or a value near the intermediate value is preferable. This can most reduce the determination time required at the initial conversion statistically.

As the initial value preset at the up/down counter, a value indicating the normal temperature or a value near this value is also preferable. This can considerably reduce the determination time required at the initial conversion when the circuit is supplied with power or is reset in a normal temperature environment.

The above and other objects of the present invention can also be accomplished by a semiconductor integrated circuit comprising:

a DRAM core unit;

a refresh controller that performs self-refresh operation of the DRAM core unit;

a self-refresh timer that controls an operation cycle of the refresh controller;

a temperature detecting unit that detects a chip temperature;

an A/D converter that converts an analog output of the temperature detecting unit into a digital output; and

an output circuit that outputs an output signal of the A/D converter or a signal based on the output signal, to outside, wherein

the self-refresh timer linearly changes the operation cycle of the refresh controller based on the chip temperature.

According to the present invention, temperature information in ananalog form is used by the self-refresh timer, and temperature information in a digital form is outputted outside. Therefore, the information relating to the chip temperature can be used inside and outside the chip.

As described above, the start-up time of the semiconductor integrated device such as a DRAM can be reduced, and the A/D conversion that is periodically performed during operation can be completed quickly. Further, information relating to the chip temperature can be used inside and outside the chip. Thus, the present invention is quite suitable for applying to a high-speed DRAM having a high data transfer rate.

### BRIEF DESCRIPTION OF THE DRAWINGS

The above and other objects, features and advantages of this invention will become more apparent by reference to the following detailed description of the invention taken in conjunction with the accompanying drawings, wherein:

FIG. 1 is a block diagram of a configuration of a semiconductor integrated circuit according to a preferred embodiment of the present invention;

FIG. 2 is a block diagram of a configuration of a temperature code generating unit shown in FIG. 1;

FIG. 3 is a circuit diagram of a detailed configuration of an A/D converter shown in FIG. 2;

FIG. 4 is a circuit diagram of a filter shown in FIG. 3;

FIG. 5 is a circuit diagram of a sample-and-hold circuit shown in FIG. 3;

FIG. 6 is a circuit diagram of a level converter shown in FIG. 2;

FIG. 7 is a graph for explaining a function of the level comparator;

FIG. 8 is a timing chart for explaining an operation of the temperature code generating unit at the start-up time;

FIG. 9 is a timing chart for explaining the operation of the temperature code generating unit at the update time;

FIG. 10 is a graph showing an example of a changing pattern of a timer cycle in a stepwise fashion with respect to a temperature; and

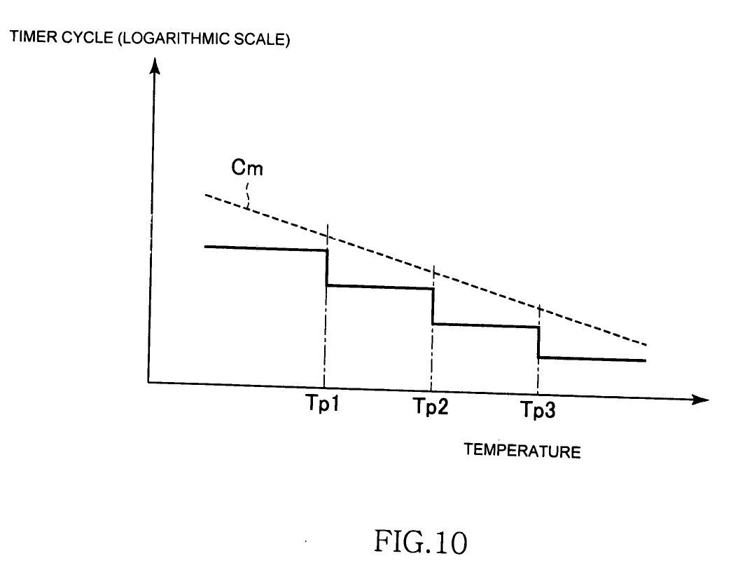

FIG. 11 is a block diagram showing a configuration of a data processing system using a semiconductor memory device according to a preferred embodiment of the present invention.

### DETAILED DESCRIPTION OF THE EMBODIMENTS

Preferred embodiments of the present invention will now be explained in detail with reference to the drawings.

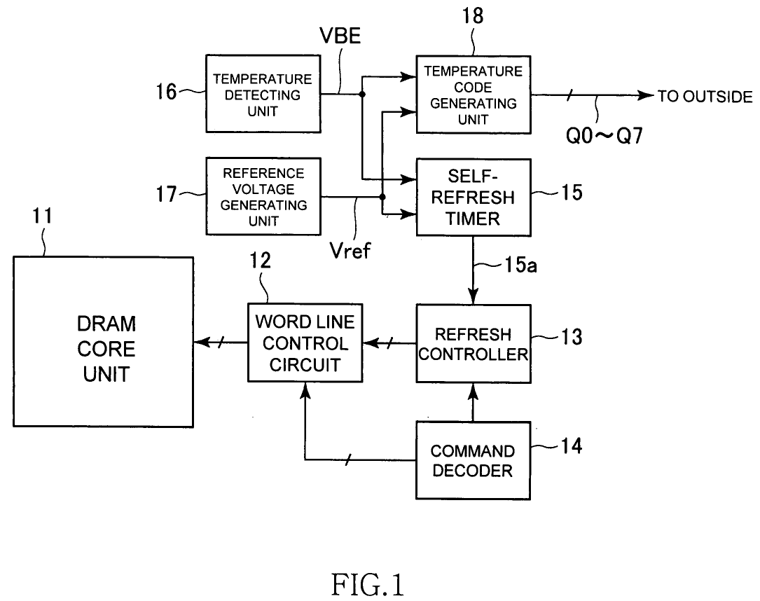

FIG. 1 is a block diagram of a configuration of a semiconductor integrated circuit according to a preferred embodiment of the present invention.

As shown in FIG. 1, the semiconductor integrated circuit according to the present embodiment is a DRAM including a DRAM core unit 11, a word line control circuit 12 that drives a word line, and a refresh controller 13 that controls refresh operation. Operations of the word line control circuit 12 and the refresh controller 13 are controlled by an output of a command decoder 14 that parses a command. For example, when a self-refresh command is issued from outside, the command decoder 14 detects this command, and makes the word line control circuit 12 and the refresh controller 13 perform the self-refresh operation. When the self-refresh operation is started, the refresh controller 13 increments (or decrements) a refresh counter based on a timer output 15a outputted from a self-refresh timer 15. Accordingly, the word line control circuit 12 successively refreshes a memory cell included in the DRAM core unit 11. The self-refresh timer 15 can linearly change the operation cycle of the refresh controller 13 based on a temperature of a chip.

A cycle in which the self-refresh timer 15 outputs the timer output 15a is controlled by a temperature signal VBE that is an analog output from a temperature detecting unit 16, and a reference voltage Vref that is generated by a reference voltage generating unit 17. The temperature detecting unit 16 is a circuit that detects a temperature within the chip. The temperature signal VBE and the reference voltage Vref are supplied also to a temperature code generating unit 18. The temperature code generating unit 18 outputs temperature signals Q0 to Q7 in digital formats to outside the chip.

Applications of the temperature signals Q0 to Q7 outputted to outside the chip are not particularly limited. These signals Q0 to Q7 are used for such control that a DRAM having a lower temperature is preferentially used, a clock frequency of a DRAM having a higher temperature is lowered, or an air volume of a cooling fan is changed according to the chip temperatures, as described above.

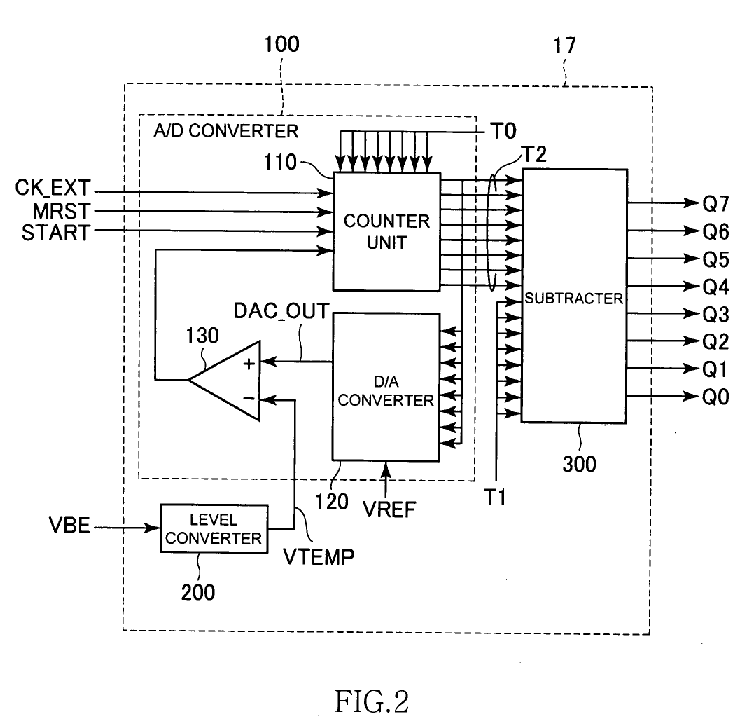

FIG. 2 is a block diagram of a configuration of the temperature code generating unit 18.

As shown in FIG. 2, the temperature code generating unit 18 includes an A/D converter 100, a level converter 200, and a subtracter 300. The A/D converter 100 converts a temperature signal VTEMP that is an analog output from the level converter 200, into a digital value using the linear search method. The A/D converter 100 includes a counter unit 110, a D/A converter 120 that converts an output of the counter unit 110 into an analog value, and a comparator 130 that compares the analog output from the D/A converter 120 and the temperature signal VTEMP.

The level converter 200 converts the temperature signal VBE as an analog output into an optimum input level for the comparator 130. The subtracter 300 subtracts measured values T2 that are outputs of the A/D converter 100 from a reference value T1 (i.e., T1-T2), to generate the temperature signals Q0 to Q7. The subtracter 300 also serves as an output circuit that outputs the temperature signals Q0 to Q7. The subtracter 300 is used to obtain amounts of changes from a reference temperature. Therefore, in some applications, the subtracter 300 can be omitted.

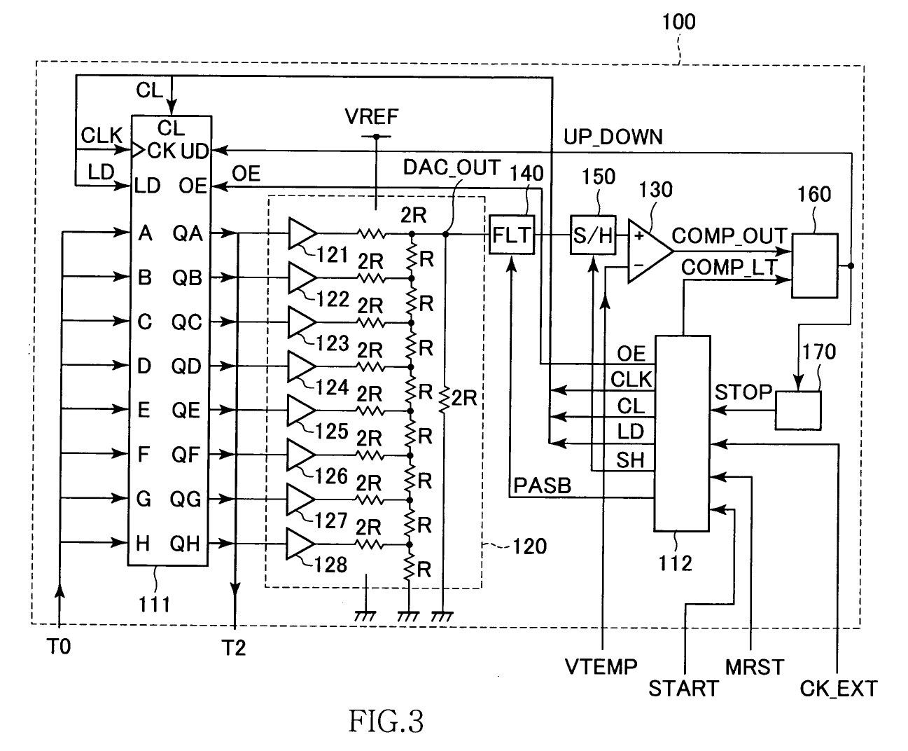

FIG. 3 is a circuit diagram of a detailed configuration of the A/D converter 100.

As shown in FIG. 3, the A/D converter 100 includes an up/down counter 111, a control circuit 112, a D/A converter 120, and a comparator 130. The up/down counter 111 and the control circuit 112 makes up the counter unit 110 shown in FIG. 2.

The up/down counter 111 performs counting-up or counting-down synchronized with a base clock CLK that is supplied to a clock terminal CK. Specifically, the up/down counter 111 performs the counting-up synchronized with the base clock CLK when an up/down signal UP_DOWN supplied to an up/down terminal UD has a low level, and performs the counting-down synchronized with the base clock CLK when the up/down signal UP_DOWN has a high level.

The up/down counter 111 has a load terminal LD. When a load signal LD supplied to the load terminal LD is activated, the up/down counter 111 presets an initial value T0 that is supplied to input terminals A to H of 8 bits. Count values (=measured values T2) are outputted through output terminals QA to QH of 8 bits. The measured values T2 are supplied to the D/A converter 120, and the subtracter 300 shown in FIG. 2.

The D/A converter 120 includes drivers 121 to 128 that are connected to the output terminals QA to QH, respectively, and plural resistors (R, 2R) that are connected in ladder form. As power supplies for the drivers, the reference voltage Vref supplied by the reference voltage generating unit 17 is employed. This configuration enables D/A conversion with an output from the output terminal QA as a most significant bit (MSB) and an output from the output terminal QH as a least significant bit (LSB). An analog output DAC_OUT generated by the D/A conversion is supplied to a non-inverting input terminal (+) of the comparator 130, through a filter 140 and a sample-and-hold circuit 150.

The filter 140 is used to make the waveform of the analog output DAC_OUT from the D/A converter 120 gentle. Because the analog output DAC_OUT from the D/A converter 120 abruptly changes at the start of the operation, which is described below, the waveform must be made gradual to reduced noises.

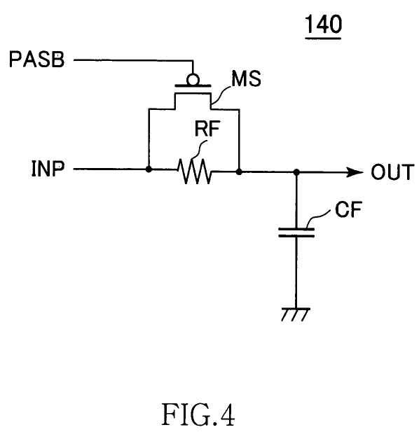

FIG. 4 is a circuit diagram of the filter 140.

As shown in FIG. 4, the filter 140 includes a resistor RF and a switch MS that are connected in parallel, and a capacitor CF that is connected between an output terminal and a ground. At the gate of the switch MS, a pass signal PASB is supplied by the control circuit 112. When the pass signal PASB has a high level, the filter 140 serves as a high-cut filter (low-pass filter) including the resistor RF and the capacitor CF. This reduces coupling noises through a gate capacitance of an input transistor (not shown) of the comparator 130. When the pass signal PASB has a low level, the switch MS is turned on, and accordingly the filter 140 outputs an input signal almost as it is.

The sample-and-hold circuit 150 is installed to hold a previous output level of the D/A converter 120. This reduces fluctuations in voltage of the D/A converter 120 at the start of the operation, thereby reducing the coupling noises through the gate capacitance of the input transistor (not shown) of the comparator 130.

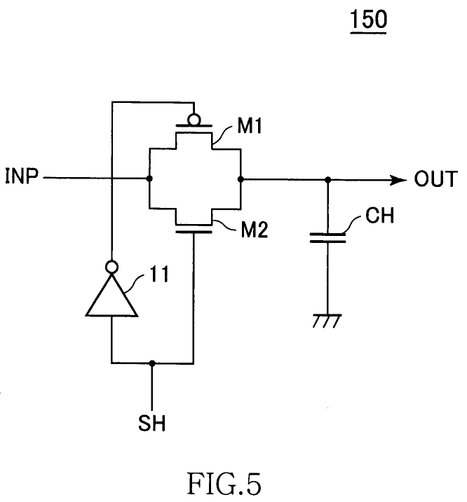

FIG. 5 is a circuit diagram of the sample-and-hold circuit 150.

As shown in FIG. 5, the sample-and-hold circuit 150 includes a transfer gate including switches M1 and M2 that are connected in parallel, and a capacitor CH that is connected between an output terminal and a ground. At the gate of the switch M2, a sample hold signal SH is supplied by the control circuit 112. At the gate of the switch M1, a signal that is obtained by inverting the sample hold signal SH with an inverter I1 is supplied. Accordingly, the sample-and-hold circuit 150 performs a sampling operation using the capacitor CH when the sample hold signal SH has a high level, and holds a level that is sampled at the capacitor CH when the sample hold signal SH has a low level.

Returning back to FIG. 3, the comparator 130 compares an output level of the D/A converter 120, which is supplied through the filter 140 and the sample-and-hold circuit 150, and a level of the temperature signal VTEMP supplied from the level converter 200 shown in FIG. 2. As a result, when the former has a higher level, a comparison signal COMP_OUT that is outputted from the comparator 130 is set at a high level. When the latter has a higher level, the comparison signal COMP_OUT is set at a low level.

The comparison signal COMP_OUT is supplied to a latch circuit 160. The latch circuit 160 latches the comparison signal COMP_OUT synchronized with a latch signal COMP_LT that is supplied from the control circuit 112. An output of the latch circuit 160 is supplied to the up/down counter 111 as the up/down signal UP_DOWN. The up/down signal UP_DOWN is supplied also to a one-shot pulse generating circuit 170.

The one-shot pulse generating circuit 170 detects that the level of the up/down signal UP_DOWN has changed plural times. When plural times of change are detected, the one-shot pulse generating circuit 170 activates a stop signal STOP as an output. The stop signal STOP is supplied to the control circuit 112.

An external clock CK_EXT, a start signal START, and a master reset signal MRST are supplied to the control circuit 112. The external clock CK_EXT is a signal from which the base clock CLK is generated. The control circuit 112 frequency-divides the external clock CK_EXT (for example, by four) to generate the base clock CLK. The external clock CK_EXT can be a clock that is obtained by frequency-dividing an original external clock. The start signal START is a signal for starting the operation of the A/D converter 100. The master reset signal MRST is a signal for resetting the up/down counter 111 and the control circuit 112.

The circuit configuration of the A/D converter 100 is as described above.

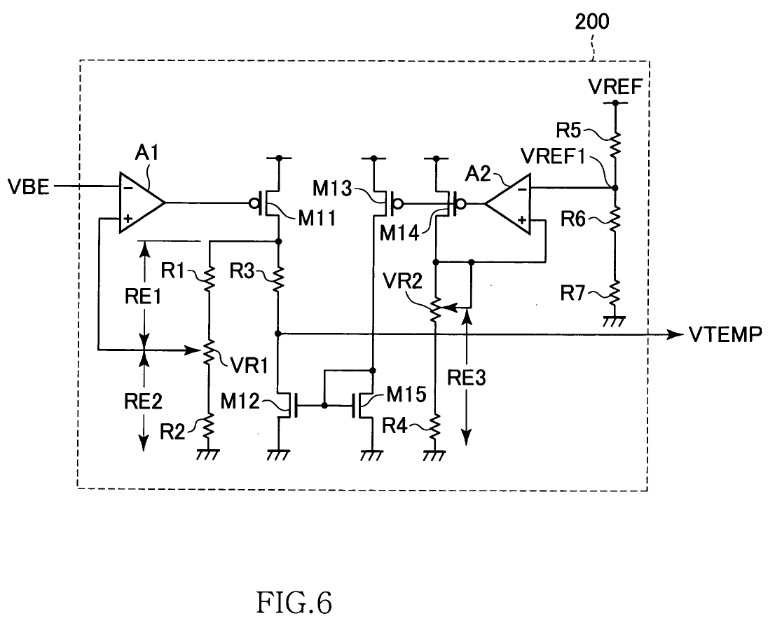

FIG. 6 is a circuit diagram of the level converter 200.

The level converter 200 converts the temperature signal VBE into an optimum input level for the comparator 130, as mentioned above. With the circuit configuration as shown in FIG. 6, an outputted temperature signal VTEMP has a level given by a Formula (1):

$$VTEMP = \frac{RE 1 + RE 2}{RE 2} VBE - \frac{R 3}{RE 3} VREF 1 \qquad ( 1 )$$

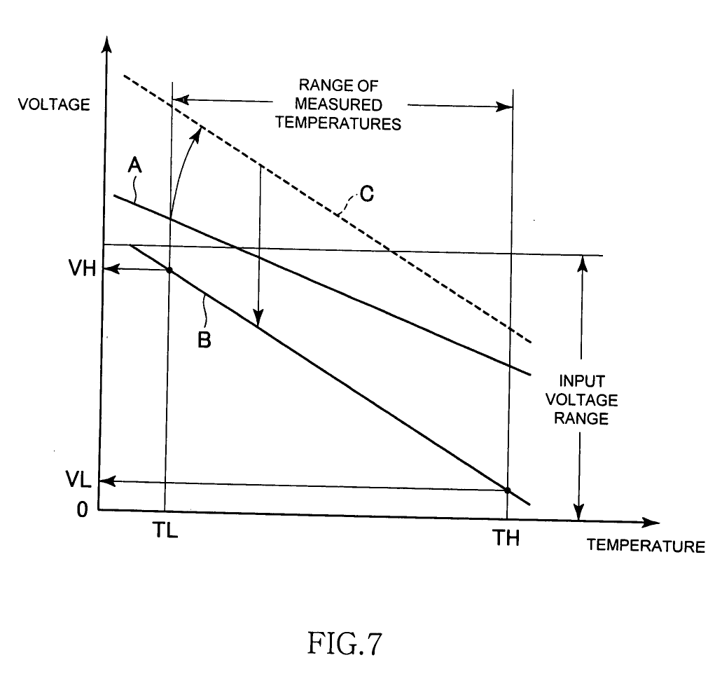

The first term of the Formula (1) indicates that the temperature dependency of VBE can be changed by a resistance ratio. Therefore, the temperature dependency of VBE can be controlled by a circuit unit that includes an amplifier A1, switches M11 and M12, resistors R1 to R3, and a variable resistor VR1. The second term of the Formula (1) indicates that VBE can be shifted in parallel with respect to the y-axis (see FIG. 7) according to resistance ratios. To shift VBE in parallel with respect to the y-axis, a circuit unit that includes an amplifier A2, switches M13 to M15, a resistor R4, and a variable resistor VR2 is controlled.

FIG. 7 is a graph for explaining a function of the level comparator 200. The x-axis represents the temperature, and the y-axis represents the voltage.

In FIG. 7, a line A shows characteristics of the temperature signal VBE, and a line B shows characteristics of the temperature signal VTEMP. In the case shown in FIG. 7, only by shifting the characteristics A of the temperature signal VBE along the y-axis, the level of the temperature signal VTEMP achieved in a range of measured temperatures from a lowest temperature TL to a highest temperature TH can be kept within an input voltage range from VL to VH of the D/A converter 120. However, the temperature dependency of VBE is usually 2 mV/° C. and has a relatively shallow slope. Therefore, a dynamic range of the D/A converter 120 cannot be fully used.

Thus, in this case, the temperature dependency of VBE is initially changed from 2 to 3 mV/° C., as shown by a ling C. This operation can be achieved by adjusting the variable resistor VR1. When the temperature dependency is increased, the obtained level greatly exceeds the input voltage range from VL to VH. To correct this, the characteristics C are moved in parallel along the y-axis. This operation can be achieved by adjusting the variable resistor VR2. In this way, the highest value VH of the input voltage range is obtained at the lowest temperature TL in the measured temperature range, and the lowest value VL of the input voltage range is obtained at the highest temperature TH in the measured temperature range, as shown by the characteristics B in FIG. 7.

As a result, for example, when the input voltage range of the D/A converter 120 is 0 to 0.8 V and the temperature dependency is 3 mV/° C., the temperatures in a range of ±128° C. can be detected logically. Of course, when a detectable temperature range is narrowed by setting a larger temperature dependency, temperature detection with higher accuracy can be achieved.

The temperature code generating unit 18 is configured as described above. The temperature signal VBE and the reference voltage Vref supplied to the temperature code generating unit 18 are also supplied commonly to the self-refresh timer 15. Therefore, only one temperature detecting unit 16 and one reference voltage generating unit 17 suffice. There is no need to provide the temperature detecting unit 16 and the reference voltage generating unit 17 separately for the temperature code generating unit 18 and the self-refresh timer 15.

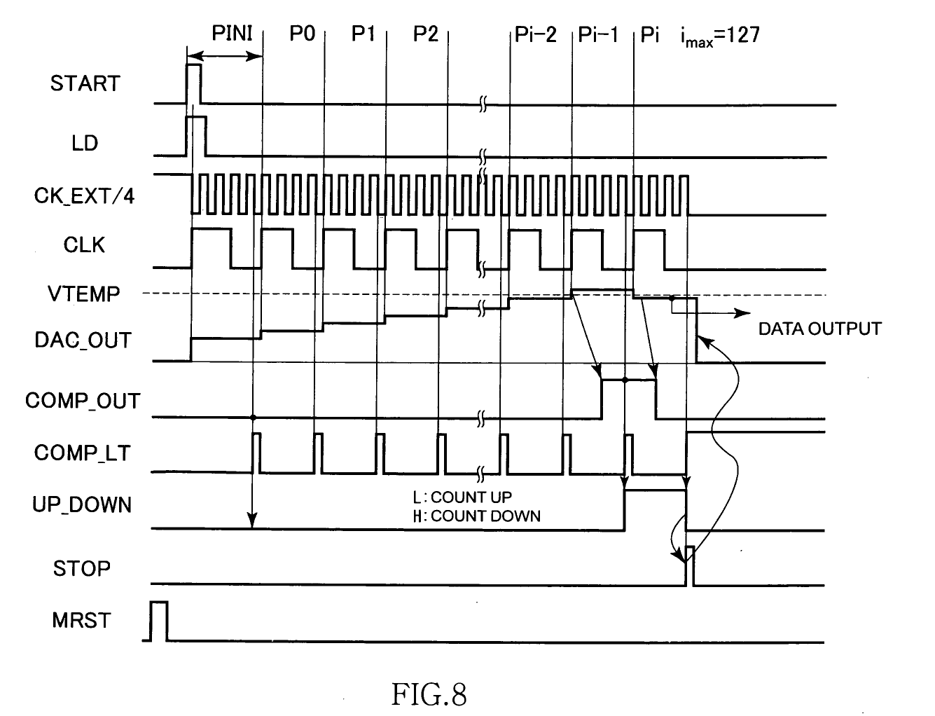

FIG. 8 is a timing chart for explaining an operation of the temperature code generating unit 18 at the start-up time. The operation shown in FIG. 8 is an operation executed in response to a command that is issued at the powering-on or resetting, or the like.

As shown in FIG. 8, at the start-up time, the master reset signal MRST is initially activated, which resets the control circuit 112. When the control circuit 112 is reset, a clear signal CL is activated, which resets the up/down counter 111. The start signal START and the load signal LD are then activated. Accordingly, the operation of the A/D converter 100 is started, and the initial value T0 is preset at the up/down counter 111. The initial value T0 must be a different value from a minimum count (00000000) and a maximum count (11111111) of the up/down counter 111. The initial value T0 is preferably an intermediate value (01111111) of the up/down counter 111 or a value near the intermediate value.

Since the A/D converter 100 used in the present embodiment adopts the linear search method, many counting operations can be required to achieve a desired count when the initial value of the up/down counter 111 is the minimum count (00000000) or the maximum count (11111111). When a different value from the minimum count (00000000) or the maximum count (11111111) is preset as the initial value T0, the number of counts required to achieve the desired count is statistically small. Particularly when the intermediate value (01111111) or a value near the intermediate value is preset as the initial value T0, the number of counts required to achieve a desired count can be statistically minimized.

It is also preferable that a value indicating the normal temperature or a value near this value is set as the initial value T0. When the temperature of the chip is near the normal temperature at the start-up time, the number of counts required to achieve a desired count is remarkable reduced.

Such preset greatly varies the analog output DAC_OUT of the D/A converter 120. In this embodiment, however, because the filter 140 is inserted between the D/A converter 120 and the comparator 130, coupling noises through the gate capacitance of the input transistor (not shown) of the comparator 130 are quite small.

In the case shown in FIG. 8, an initial output DAC_OUT of the D/A converter 120 does not reach the level of the temperature signal VTEMP. Therefore, the comparison signal COMP_OUT outputted from the comparator 130 has a low level. Before the base clock CLK that is obtained by frequency-dividing the external clock CK_EXT (for example, by four) is activated, the latch signal COMP_LT is activated, so that the comparison signal COMP_OUT is captured by the latch circuit 160. Accordingly, an initial cycle PINI is completed.

When the base clock CLK is activated, the up/down counter 111 performs counting-up or counting-down according to the logic level of the comparison signal COMP_OUT captured by the latch circuit 160. In this case, since the comparison signal COMP_OUT captured by the latch circuit 160 has a low level, the up/down counter 111 perform counting-up in response to the activation of the base clock CLK. This leads to one step of increase of the analog output DAC_OUT of the D/A converter 120.

Before the subsequent activation of the base clock CLK, the latch signal COMP_LT is activated, and a new comparison signal COMP_OUT is captured by the latch circuit 160. This completes a conversion cycle P0.

Conversion cycles P1, P2, P3, . . . are subsequently performed synchronized with the base clock CLK, and the analog output DAC_OUT of the D/A converter 120 changes (increases in this case) one step by one step. When the analog output DAC_OUT of the D/A converter 120 exceeds the level of the temperature signal VTEP, the comparison signal COMP_OUT is inverted into a high level, and the up/down signal UP_DOWN is correspondingly inverted into a high level.

The up/down counter 111 performs counting-down, and the analog output DAC_OUT of the D/A converter 120 decreases by one step. When the inverting of the up/down signal UP_DOWN occurs plural times (twice in this case) in a row, the one-shot pulse generating circuit 170 activates the stop signal STOP to stop the operation of the control circuit 112. Because the base clock CLK is also stopped accordingly, the outputs of the up/down counter 111 are fixed and supplied to the subtracter 300 shown in FIG. 2 as the measured values T2.

The reason why the stop signal STOP is activated provided that the inverting of the up/down signal UP_DOWN occurs plural times in a row is not to activate the stop signal STOP when the up/down signal UP_DOWN is erroneously inverted due to power supply noises that are asynchronous with the back clock CLK.

The subtracter 300 subtracts the measured values T2 outputted from the A/D converter 100 from the reference value T1 (T1-T2), to generate the temperature signals Q0 to Q7. The generated temperature signals Q0 to Q7 are outputted to outside the chip as shown in FIG. 1. By deactivating an enable signal OE, all of the outputs of the up/down counter 111 are made to have low levels.

In the present embodiment, the value mentioned above is preset at the up/down counter 111 as the initial value T0. Therefore, the stop signal STOP can be generated with a smaller number of counts as compared to the case of using the minimum count (00000000) or the maximum count (11111111) as the initial value T0. More specifically, assuming that the intermediate value (01111111) is preset as the initial value T0, the number of counts required to achieve a desired count is 128 counts at the most. This is less than 256 counts, which is the maximum number of counts in the case of using the minimum count (00000000) or the maximum count (11111111) as the initial value T0.

After completion of the operation, the enable signal OE is deactivated to make all outputs from the up/down counter 111 have low levels. Accordingly, unnecessary power consumption by the D/A converter 120 is eliminated.

The temperature code generating unit 18 operates as described above at the start-up time. An operation of the temperature code generating unit 18 at the update time is described next.

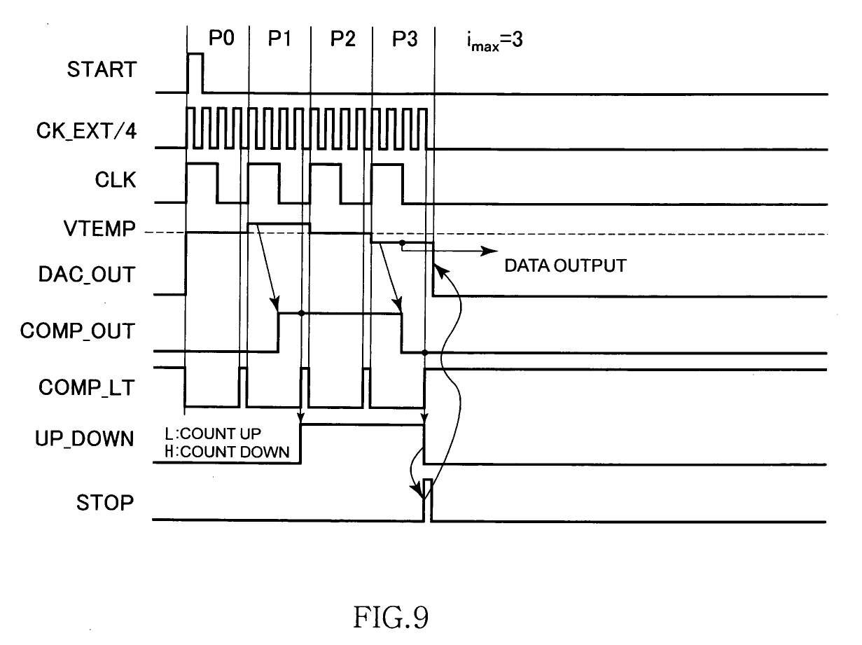

FIG. 9 is a timing chart for explaining the operation of the temperature code generating unit 18 at the update time. The operation shown in FIG. 9 is executed in response to a predetermined command that is issued periodically during the normal operation.

As shown in FIG. 9, at the update time, i.e., at the second or subsequent operation, the start signal START is activated first, to resume the operation of the control circuit 112. In response to this, the control circuit 112 activates the enable signal OE to output a count of the up/down counter 111.

In this case, the previous count is held as the count of the up/down counter 111. Therefore, the level of the output DAC_OUT of the D/A converter 120 should be near the temperature signal VTEMP unless an abrupt temperature change occurs. However, in this embodiment, the sample-and-hold circuit 150 is inserted between the D/A converter 120 and the comparator 130 to hold the previous level. Therefore, few fluctuations occur in the output level of the D/A converter 120 at the start of the update operation. Accordingly, coupling noises through the gate capacitance of the input transistor (not shown) of the comparator 130 hardly occur.

The following operation is the same as the operation mentioned above. That is, the conversion cycles P0, P1, P2, . . . are executed synchronized with the base clock CLK, and when the inverting of the up/down signal UP_DOWN occurs plural times (twice in this embodiment) in a row, the stop signal STOP is activated to stop the operation of the control circuit 112. Accordingly, the outputs of the up/down counter 111 are fixed, and the measured values T2 are supplied to the subtracter 300. By deactivating the enable signal OE, all the outputs from the up/down counter 111 are made to have low levels.

At the updating, even when the inverting of the up/down signal UP_DOWN does not occur plural times (twice in this embodiment) in a row, the update operation can be forced to terminate at a predetermined number of clocks. Since the operation of the DRAM core unit 11 is stopped during the update operation, a time period during which the update operation is executed must be limited to a short time.

In the A/D converter 100 according to the present embodiment, since a different initial value from the minimum value or the maximum value is preset at the up/down counter 111, the determination time at the initial conversion can be reduced although the linear search method is adopted. Accordingly, the start-up time can be reduced at the powering-on or resetting.

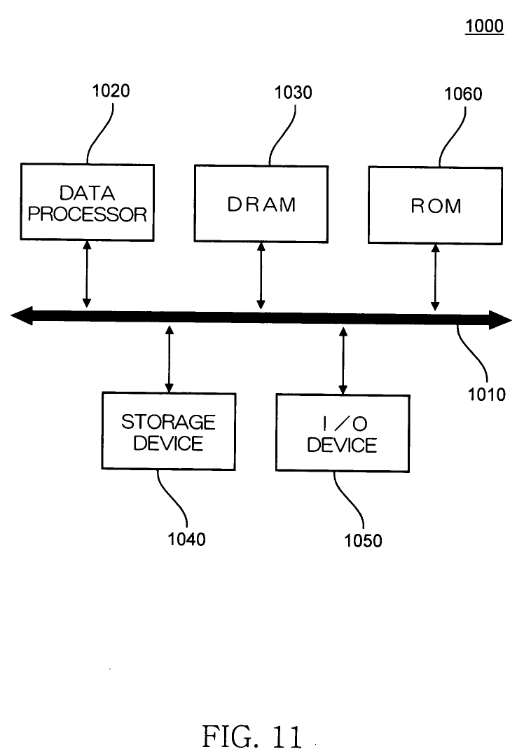

FIG. 11 is a block diagram showing a configuration of a data processing system 1000 using a semiconductor memory device according to a preferred embodiment of the present invention. The semiconductor memory device according to the present embodiment is a DRAM.

The data processing system 1000 shown in FIG. 11 includes a data processor 1020 and a semiconductor memory device (DRAM) 1030 according to the present embodiment connected to each other via a system bus 1010. The data processor 1020 includes a microprocessor (MPU) and a digital signal processor (DSP), for example. However, the constituent elements of the data processor 1020 are not limited to these. In FIG. 11, while the data processor 1020 and the DRAM 1030 are connected to each other via the system bus 1010, to simplify the explanation, the data processor 1020 and the DRAM 1030 can be connected to each other via a local bus without via the system bus 1010.

While only one set of the system bus 1010 is drawn to simplify the explanation in FIG. 11, the system bus can be set in series or in parallel via the connector according to need. In the memory system data processing system shown in FIG. 11, a storage device 1040, an I/O device 1050, and a ROM 1060 are connected to the system bus 1010. However, these are not necessarily essential constituent elements of the invention.

The storage device 1040 includes a hard disk drive, an optical disk drive, and a flash memory. The I/O device 1050 includes a display device such as a liquid-crystal display, and an input device such as a keyboard and a mouse. The I/O device 1050 may be any one of the input device and the output device. Further, while each one constituent element is drawn in FIG. 11 to simplify the explanation, the number of each constituent element is not limited to one, and may be one or two or more.

The present invention is in no way limited to the aforementioned embodiments, but rather various modifications are possible within the scope of the invention as recited in the claims, and naturally these modifications are included within the scope of the invention.

In the present embodiment, an example in which the present invention is applied to a DRAM has been explained. However, applications of the present invention are not limited thereto, and the invention is also applicable to a semiconductor integrated circuit of other types.

According to the present invention, the start-up time of the semiconductor integrated device such as a DRAM can be reduced, and the A/D conversion that is periodically performed during operation can be completed quickly. Further, information relating to the temperature of the chip can be used inside and outside the chip. Thus, the present invention is quite suitable for applying to a high-speed DRAM having a high data transfer rate.

What is claimed is:

1. A semiconductor integrated circuit comprising:
a temperature detecting unit that detects a chip temperature; and
an A/D converter that converts an analog output of the temperature detecting unit into a digital output,
the A/D converter including:
an up/down counter;
a D/A converter that converts an output from the up/down counter into an analog output; and
a comparator that compares the analog output of the D/A converter and the analog output of the temperature detecting unit,
the up/down counter can preset an initial value different from a minimum value or a maximum value.

2. The semiconductor integrated circuit as claimed in claim 1, wherein the initial value is about an intermediate value of the up/down counter.

3. The semiconductor integrated circuit as claimed in claim 1, wherein the initial value is about a value indicating a normal temperature.

4. The semiconductor integrated circuit as claimed in claim 1, wherein the A/D converter further includes a control circuit that stops count of the up/down counter in response to plural times of change of an output of the comparator.

5. The semiconductor integrated circuit as claimed in claim 1, further comprising an output circuit that outputs an output signal from the A/D converter or a signal based on the output signal, to outside.

6. The semiconductor integrated circuit as claimed in claim 1, further comprising:
a DRAM core unit;
a refresh controller that performs self-refresh operation of the DRAM core unit; and
a self-refresh timer that controls an operation cycle of the refresh controller,
wherein the self-refresh timer linearly changes the operation cycle of the refresh controller based on the chip temperature.

7. The semiconductor integrated circuit as claimed in claim 1, wherein the A/D converter further comprises a filter that makes a waveform of the analog output of the D/A converter gentle.

8. The semiconductor integrated circuit as claimed in claim 1, wherein the A/D converter further comprises a sample-and-hold circuit that holds the analog output of the D/A converter.

9. A semiconductor integrated circuit comprising:
a temperature detecting unit that detects a chip temperature; and
an A/D converter that converts an analog output of the temperature detecting unit into a digital output,
the A/D converter including:
an up/down counter;
a D/A converter that converts an output of the up/down counter into an analog output; and
a comparator that compares the analog output of the D/A converter and the analog output of the temperature detecting unit,
wherein the semiconductor integrated circuit performs A/D conversion by using a predetermined value that is different from a minimum value or a maximum value in the up/down counter as an initial value when a first command is issued, and performs A/D conversion by using a previous count as the initial value when a second command is issued.

10. The semiconductor integrated circuit as claimed in claim 9, wherein the first command is issued at a reset time.

11. The semiconductor integrated circuit as claimed in claim 9, wherein the second command is periodically issued during a normal operation.

12. A semiconductor integrated circuit comprising:
a DRAM core unit;
a refresh controller that performs self-refresh operation of the DRAM core unit;
a self-refresh timer that controls an operation cycle of the refresh controller;
a temperature detecting unit that detects a chip temperature;
an A/D converter that converts an analog output of the temperature detecting unit into a digital output; and
an output circuit that outputs an output signal of the A/D converter or a signal based on the output signal, to outside, wherein
the self-refresh timer linearly changes the operation cycle of the refresh controller based on the chip temperature.

13. The semiconductor integrated circuit as claimed in claim 12, wherein the self-refresh timer linearly changes the operation cycle of the refresh controller based on the analog output from the temperature detecting unit.

14. A data processing system comprising a data processor and a semiconductor memory device, wherein the semiconductor memory device includes:
a temperature detecting unit that detects a chip temperature; and
an A/D converter that converts an analog output of the temperature detecting unit into a digital output,
the A/D converter having:
an up/down counter;
a D/A converter that converts an output from the up/down counter into an analog output; and
a comparator that compares the analog output of the D/A converter and the analog output of the temperature detecting unit,
the up/down counter can preset an initial value different from a minimum value or a maximum value.
